(19) United States
(12) Patent Application Publication
(10) Pub. No.: US 2019/0390719 A1
(43) Pub. Date: Dec. 26, 2019

(54) PISTON ALIGNMENT DEVICE

(71) Applicant: Schaeffler Technologies AG & Co. KG, Herzogenaurach (DE)

(72) Inventors: Miguel HUERTA, Puebla (MX); Ivan Alejandro ASCENCION, Puebla (MX)

(21) Appl. No.: 16/017,250

(22) Filed: Jun. 25, 2018

(51) Int. Cl. F16D 25/08; F16H 45/02; F16D 13/70

(52) U.S. Cl. CPC F16D 25/082; F16D 13/70; F16H 45/02

(57) ABSTRACT

A piston assembly for a torque converter includes a piston plate. The piston plate includes an axial inner crown, a radial annular surface, an axial skirt, and a notch. The axial inner crown includes an inner annular edge. The radial annular surface is coupled to the axial inner crown. The axial skirt includes an outer annular edge and is coupled to the radial annular surface. The notch is disposed in the outer annular edge of the axial skirt and is configured to align the piston assembly relative to the torque converter. The notch can be crescent or half-moon shaped, and the notch can be a plurality of notches. The notch is configured to align the piston assembly for a blind riveting assembly process of the torque converter.

### BACKGROUND

### Field

The present disclosure relates generally to torque converters and piston assemblies. More specifically, embodiments of the present disclosure relate to alignment of a piston plate in a torque converter.

### Background

A closed piston torque converter includes a lock-up clutch to engage or disengage the input and output shafts. The lock-up clutch includes a drive plate and a piston plate which is hydraulically controlled to engage or disengage friction contact surfaces. Alignment of the piston plate is important for assembly processes of the torque converter.

### BRIEF SUMMARY

In some embodiments, a piston assembly for a torque converter includes a piston plate. In some embodiments, the piston plate includes an axial inner crown, a radial annular surface, an axial skirt, and a notch. In some embodiments, the axial inner crown includes an inner annular edge. In some embodiments, the radial annular surface is coupled to the axial inner crown. In some embodiments, the axial skirt includes an outer annular edge and is coupled to the radial annular surface. In some embodiments, the notch is disposed in the outer annular edge of the axial skirt and is configured to align the piston assembly relative to the torque converter.

In some embodiments, the notch is crescent or half-moon shaped. In some embodiments, the notch is an arc shaped bevel. In some embodiments, the notch is a plurality of notches. In some embodiments, each notch is equally spaced from one another on the outer annular edge. In some embodiments, the notch extends radially inward from the outer annular edge to less than a cross sectional centerline of the axial skirt. In some embodiments, the notch is configured to align the piston assembly for a blind riveting assembly process of the torque converter. In some embodiments, the notch is stamped into the outer annular edge.

In some embodiments, the piston assembly further includes an inner rivet disposed in the radial annular surface. In some embodiments, the piston assembly further includes an inner leaf spring configured to attach to the inner rivet. In some embodiments, the piston assembly further includes an outer rivet disposed in the radial annular surface. In some embodiments, the piston assembly further includes an outer leaf spring configured to attach to the outer rivet.

In some embodiments, a torque converter includes a cover, a drive plate, and a piston assembly. In some embodiments, the cover includes an inner radial surface. In some embodiments, the drive plate includes an annular plate and at least one aperture. In some embodiments, the drive plate is configured to be rotationally fixed to the cover. In some embodiments, the piston assembly is coupled to the drive plate. In some embodiments, the piston assembly of the torque converter includes a piston plate and a leaf spring. In some embodiments, the piston plate includes an axial inner crown, a radial annular surface, an axial skirt, a notch, and a piston rivet. In some embodiments, the axial inner crown includes an inner annular edge. In some embodiments, the radial annular surface is coupled to the axial inner crown. In some embodiments, the axial skirt includes an outer annular edge and is coupled to the radial annular surface. In some embodiments, the notch disposed in the outer annular edge of the axial skirt and is configured to align the piston assembly relative to the torque converter. In some embodiments, the piston rivet is disposed in the radial annular surface. In some embodiments, the leaf spring, having a first end and a second end, is attached to the piston rivet. In some embodiments, the first end of the leaf spring is attached to the drive plate and the second end is attached to the piston rivet such that the piston assembly is axially moveable and rotationally immovable relative to the cover. In some embodiments, the first end of the leaf spring is attached to the cover and the second end is attached to the piston rivet such that the piston assembly is axially moveable and rotationally immovable relative to the cover. In some embodiments, the torque converter is a closed piston three passage torque converter. In some embodiments, the torque converter is a closed piston four passage torque converter.

In some embodiments, the notch is crescent or half-moon shaped. In some embodiments, the notch is an arc shaped bevel. In some embodiments, the notch is a plurality of notches. In some embodiments, each notch is equally spaced from one another on the outer annular edge. In some embodiments, the notch extends radially inward from the outer annular edge to less than a cross sectional centerline of the axial skirt. In some embodiments, the notch is configured to align the piston assembly for a blind riveting assembly process of the torque converter. In some embodiments, the notch is stamped into the outer annular edge.

In some embodiments, a piston plate for a torque converter includes an axial inner crown, a radial annular surface, an axial skirt, and a notch. In some embodiments, the axial inner crown includes an inner annular edge. In some embodiments, the radial annular surface is coupled to the axial inner crown. In some embodiments, the axial skirt includes an outer annular edge and is coupled to the radial annular surface. In some embodiments, the notch is disposed in the outer annular edge of the axial skirt. In some embodiments, the notch is configured to align the piston plate relative to the torque converter. In some embodiments, the notch is crescent or half-moon shaped. In some embodiments, the notch is a plurality of notches.

### BRIEF DESCRIPTION OF THE DRAWINGS

The accompanying drawings, which are incorporated herein and form a part of the specification, illustrate the embodiments and, together with the description, further serve to explain the principles and to enable a person skilled in the relevant art(s) to make and use the embodiments. Objects and advantages of illustrative, non-limiting embodiments will become more apparent by describing them in detail with reference to the attached drawings.

FIG. 1 illustrates a perspective view of a piston plate for a torque converter according to an embodiment.

FIG. 2 illustrates a partial cross-sectional view of a torque converter with the piston plate of FIG. 1 according to an embodiment.

FIG. 3 illustrates a partial cross-sectional view of a torque converter with the piston plate of FIG. 1 according to an embodiment.

The features and advantages of the embodiments will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

Embodiments of the present disclosure are described in detail with reference to embodiments thereof as illustrated in the accompanying drawings. References to “one embodiment,” “an embodiment,” “some embodiments,” etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The following examples are illustrative, but not limiting, of the present embodiments. Other suitable modifications and adaptations of the variety of conditions and parameters normally encountered in the field, and which would be apparent to those skilled in the art, are within the spirit and scope of the disclosure.

Torque converters are used in mechanics and fluid dynamics. A turbine and an impeller in a torque converter direct fluid in opposite directions during normal operation and create a fluid coupling with no torque. Generally, stator assemblies redirect the flow of fluid exiting the turbine before being reintroduced to the impeller. A stator assembly disposed between the turbine and the impeller creates a multiplication of torque. Typically, a stator is fixed against rotation in one direction and allowed to free-wheel in the opposite direction through the use of a one-way clutch.

A closed piston torque converter includes a lock-up clutch to engage or disengage the input and output shafts. For example, the closed piston torque converter can be a three passage torque converter. Alternatively, the closed piston torque converter can be a four passage torque converter. When the lock-up clutch is engaged, the input and output shafts are locked and rotate at the same speed. When the lock-up clutch is slipping, the input and output shafts are locked, but rotate at different speeds. When the lock-up clutch is disengaged, the input and output shafts are unlocked and rotate at different speeds.

The lock-up clutch includes a drive plate and a piston plate. The piston plate is hydraulically controlled to engage or disengage friction contact surfaces in the torque converter. Valves open and close fluid passages in the closed torque converter to supply and discharge fluid between the cover of the torque converter and the piston plate. When the piston plate is pressurized equally on both sides, the lock-up clutch is disengaged and the piston plate cannot engage friction contact surfaces. When pressurized fluid between the cover of the torque converter and the piston plate escapes, the lock-up clutch is engaged and the difference in pressure across the two sides of the piston plate causes the piston plate to slide toward the cover and engage friction contact surfaces.

A closed piston torque converter may include a piston plate disposed between the turbine and the cover of the torque converter about an axis of rotation. During riveting operations, there is a need for proper alignment of the piston plate relative to the torque converter. Previous designs requiring holes on an outer diameter of the piston plate for alignment are often undesirable and subsume a significant amount of axial space in the torque converter. Further, closed chamber torque converter designs cannot have holes due to the necessary seals. Hence, there is a need for improved piston plate designs since reduced space and closed chamber designs cannot have holes on an outer diameter of the piston plate.

During blind riveting, for proper alignment of the piston plate relative to the torque converter there is a need to simplify the design, reduce axial space, and ensure the functional surfaces of the piston plate or a seal are not compromised. A guide on an outer diameter of the piston plate improves alignment, riveting operations, and implementation, while ensuring the piston plate or seals are not compromised or damaged. The herein described piston plate with a notch is useful for new compact closed torque converter designs and reduces complexity, axial space, and overall cost, and can be used for alignment in multiple riveting operations.

Embodiments of a piston plate for a piston assembly and related systems are described herein. Embodiments include a piston plate with a notch for a piston assembly or for a closed piston torque converter. In some embodiments, a piston plate with a notch can be used for a closed piston three passage torque converter. In some embodiments, a piston plate with a notch can be used for a closed piston four passage torque converter. In embodiments, the piston plate may save axial space, improve alignment, and/or ensure the functional surfaces of the piston plate or a seal are not compromised.

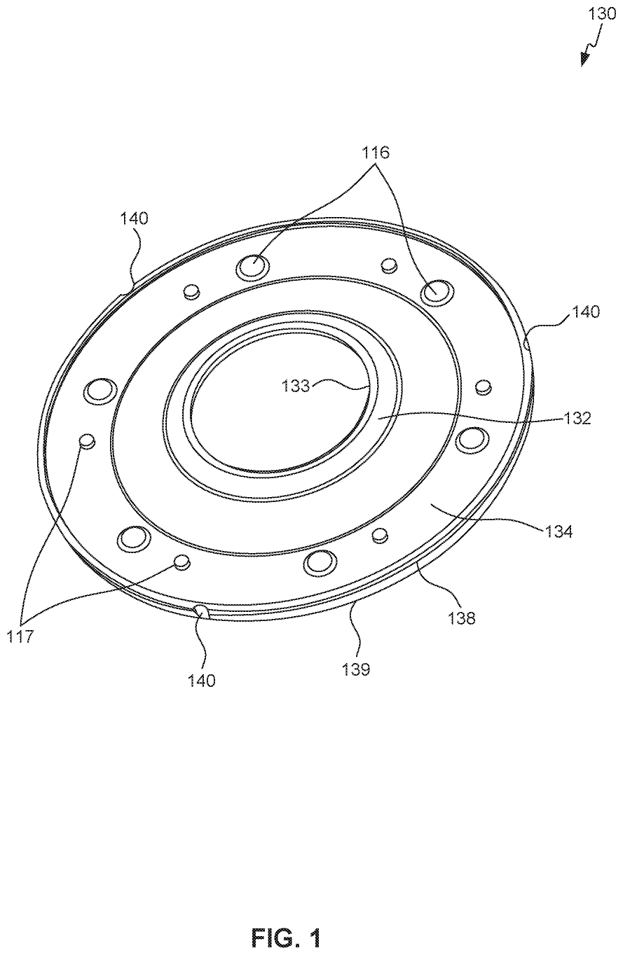

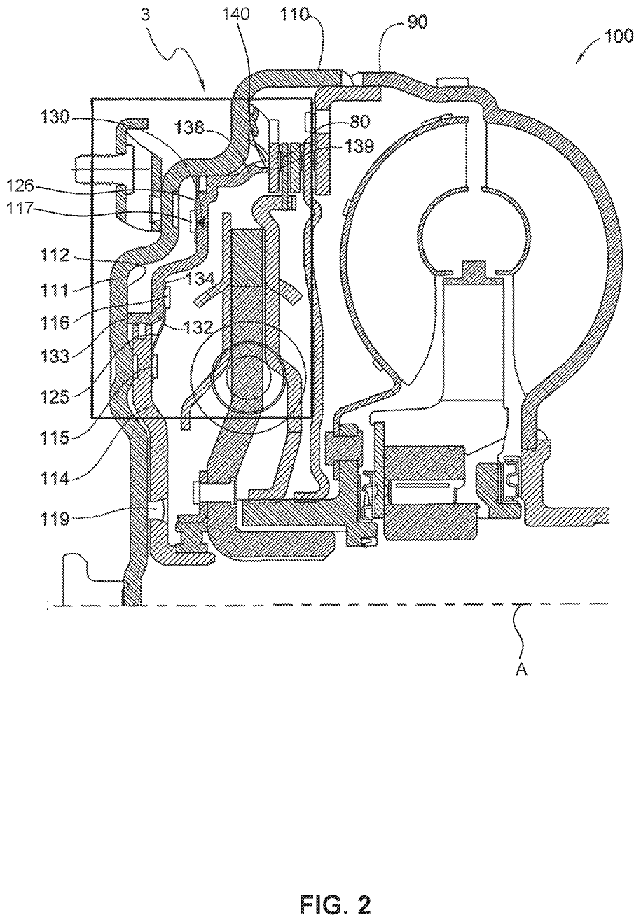

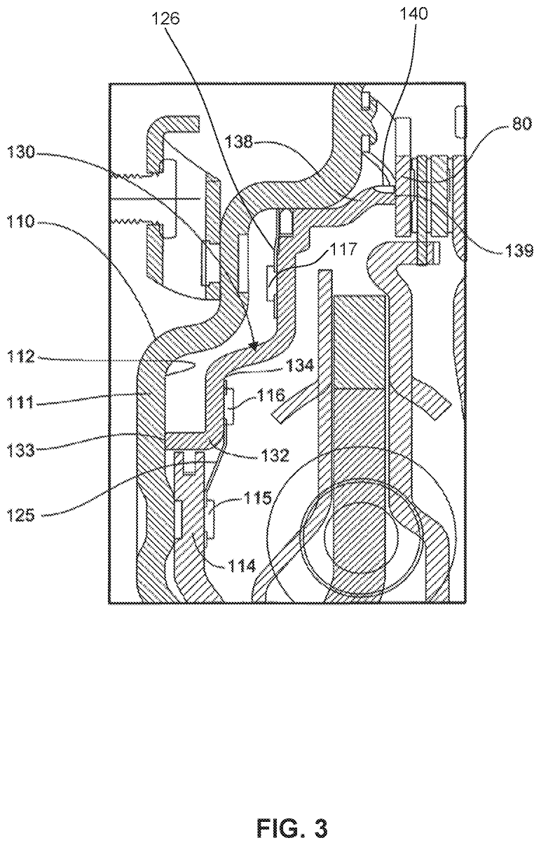

Referring to FIG. 1, piston plate 130 is defined by axial piston crown 132, radial annular piston surface 134, axial piston skirt 138, and notch 140 to form a generally flat annulus. Piston plate 130 is configured to be aligned, via notch 140, relative to a torque converter 100 for a riveting assembly process in the torque converter 100. Piston plate 130, in conjunction with a drive plate 80 and a cover 110 of torque converter 100, as shown in FIG. 2, is configured to function as a lock-up clutch to engage or disengage input and output shafts (not shown) of torque converter 100. Piston plate 130 is hydraulically controlled to engage or disengage friction contact surfaces (not shown) on an inner radial cover surface 112, as shown in FIGS. 2 and 3. When piston plate 130 is pressurized equally on both sides, piston plate 130 cannot engage inner radial cover surface 112. When piston plate 130 is pressurized unequally on both sides, the difference in pressure across the two sides of piston plate 130 causes piston plate 130 to slide toward cover 110 of torque converter 100 and piston plate 130 can engage inner radial cover surface 112. Axial piston crown 132 includes inner annular piston edge 133 which defines an inner diameter (ID) of piston plate 130. Axial piston crown 132 is coupled to radial annular piston surface 134 and forms a raised annulus extending away from a backside of radial annular piston surface 134. Axial piston skirt 138 includes outer annular piston edge 139 which defines an outer diameter (OD) of piston plate 130. Axial piston skirt 138 is coupled to radial annular piston surface 134 and forms a raised annulus extending away from a frontside of radial annular piston surface 134. Axial piston skirt 138 includes notch 140 on outer annular piston edge 139.

Piston plate 130 can be formed by known manufacturing processes and methods in the art, including, but not limited to molding (e.g., injection, reaction injection, sintering, laminating, matrix, blow, compression, film insert, gas assist, rotational, structural foam, piece, plastic, casting, spin casting, die casting, transfer, thermoforming, vacuum, etc.), machining (e.g., milling, turning, drilling, reaming, sawing, filing, fettling, boring, broaching, shaping, planing, tapping, electrical discharge, EDM, electrochemical, electron beam, photochemical, ultrasonic, laser cutting, water jet cutting, etc.), extrusion (e.g., profile, hot, cold, warm, friction, micro, direct, indirect, hydrostatic, etc.), or any other suitable process or method. Piston plate 130 may be made of a suitable material or materials, including, but not limited to, a metal (e.g., copper, aluminum, titanium, iron, cast iron, steel, etc.), a polymer (e.g., plastic, thermoplastic, polyamide, Torlon®, polytetrafluoroethylene (PTFE), polyether, polyether ether ketone (PEEK), resin, polyoxymethylene, phenolics, acetals, nylon, rigid machinable polymer, etc.), a ceramic (e.g., zirconia, silicon nitride, alumina, silicon carbide, etc.), or any other suitable material(s). In some embodiments, piston plate 130 is rigid. In some embodiments, piston plate 130 is flexible. In some embodiments, piston plate 130 has suitable mechanical properties, wear resistance, and/or ample flexibility. In some embodiments, piston plate 130 is a single formed piece. In some embodiments, piston plate 130 is integrally molded. In some embodiments, piston plate 130 is integrally machined. In some embodiments, piston plate 130 is integrally extruded. In some embodiments, piston plate 130 is monolithic. In one embodiment, piston plate 130 may be a piston assembly, lock-up piston, clutch piston, clutch piston plate, piston clutch, piston lock-up clutch, or simply a piston.

Notch 140 is formed on outer annular piston edge 139 of piston plate 130. Notch 140 is configured to align piston plate 130 relative to torque converter 100. Notch 140 is configured to align piston plate 130 for a riveting assembly process of torque converter 100. In one embodiment, notch 140 is stamped into outer annular piston edge 139 of piston plate 130. In one embodiment, notch 140 is configured to align piston plate 130 for a blind riveting assembly process of torque converter 100. In one embodiment, notch 140 is configured to align piston plate 130 relative to drive plate 80. In one embodiment, notch 140 is crescent or half-moon shaped. In one embodiment, notch 140 is an arc shaped bevel. In one embodiment, as shown in FIG. 1, notch 140 is a plurality of notches 140. For example, the plurality of notches 140 can each be equally spaced apart from one another on outer annular piston edge 139. In one embodiment, a plurality of notches 140 are disposed asymmetrically on outer annular piston edge 139. In one embodiment, notch 140 extends radially inward from outer annular piston edge 139 to less than a cross sectional centerline of axial piston skirt 138. In one embodiment, notch 140 extends along the entire axial length of axial piston skirt 138. In one embodiment, notch 140 extends along less than an axial centerline length of axial piston skirt 138. In some embodiments, notch 140 is a concave shaped recess. In some embodiments, a concave shaped recess can be formed as notch 140 by machining or molding piston plate 130. In some embodiments, a concave shaped recess can be formed as notch 140 by machining or molding axial piston skirt 138. In some embodiments, notch 140 can be a bevel, a chamfer, an arc shape, or any other suitable shape to align piston plate 130 without compromising a functional surface of piston plate 130 or a seal (not shown). In one embodiment, piston plate 130 includes notch 140 that is stamped, for example, as shown in FIG. 1.

In one embodiment, axial piston crown 132 can extend above radial annular piston surface 134. For example, as shown in FIG. 1, axial piston crown 132 can be an arc shaped toroid extending beyond a backside of radial annular piston surface 134. In one embodiment, radial annular piston surface 134 can include inner piston rivet 116 or outer piston rivet 117. For example, as shown in FIG. 1, inner piston rivet 116 can be disposed in radial annular piston surface 134 and extend beyond a frontside of radial annular piston surface 134. For example, as shown in FIG. 1, outer piston rivet 117 can be disposed in radial annular piston surface 134 and extend beyond a backside of radial annular piston surface 134. In some embodiments, radial annular piston surface 134 can include a plurality of inner piston rivets 116. For example, as shown in FIG. 1, the plurality of inner piston rivets 116 can each be equally spaced from one another in radial annular piston surface 134. In some embodiments, radial annular piston surface 134 can include a plurality of outer piston rivets 117. For example, as shown in FIG. 1, the plurality of outer piston rivets 117 can each be equally spaced from one another in radial annular piston surface 134.

In some embodiments, piston rivets 116, 117 may be formed in radial annular piston surface 134 by molding, machining, extrusion, or any other suitable process or method. In some embodiments, piston rivets 116, 117 are symmetrically arranged on radial annular piston surface 134. In some embodiments, piston rivets 116, 117 may be formed in radial annular piston surface 134 manually, automatically, or by any other suitable process or method. In some embodiments, piston plate 130 includes at least two inner piston rivets 116. For example, inner piston rivets 116 can be spaced apart by about 180 degrees. In some embodiments, piston plate 130 includes at least four inner piston rivets 116. For example, inner piston rivets 116 are spaced apart by about 90 degrees. In some embodiments, piston plate 130 includes at least six inner piston rivets 116. For example, inner piston rivets 116 are spaced apart by about 60 degrees. In some embodiments, piston plate 130 includes at least two outer piston rivets 117. For example, outer piston rivets 117 can be spaced apart by about 180 degrees. In some embodiments, piston plate 130 includes at least four outer piston rivets 117. For example, outer piston rivets 117 are spaced apart by about 90 degrees. In some embodiments, piston plate 130 includes at least six outer piston rivets 117. For example, outer piston rivets 117 are spaced apart by about 60 degrees.

Referring to FIGS. 2 and 3, torque converter 100 includes stator (not shown), turbine (not shown), impeller (not shown), drive plate 80, impeller shell 90, cover 110, and piston plate 130, which are all operatively arranged to rotate about rotational axis A. The embodiments of piston plate 130 shown in FIG. 1, and the embodiments of torque converter 100 with piston plate 130 are similar. Detailed operation of a torque converter with a stator, a turbine, and an impeller has been previously discussed in WIPO International Application No. PCT/US2015/023531, the disclosure of which is incorporated herein by reference thereto, whose operating principles are similar to the embodiments of torque converter 100 shown in FIG. 2 and will not be discussed further. The term “axial” refers to that which extends generally along or parallel to rotational axis A, and the term “radial” refers to that which extends generally orthogonal or perpendicular to rotational axis A.

Cover 110 includes radial cover wall 111 and radial annular cover component 114, and piston plate 130 is disposed between cover 110 and turbine (not shown). Radial cover wall 111 includes inner radial cover surface 112. Radial annular cover component 114 is fixedly attached to inner radial cover surface 112 via radial annular cover rivet 119. Radial annular cover component 114 can include cover rivet 115. Drive plate 80 is a radial annular plate. In one embodiment, a leaf spring (not shown) is used to secure piston plate 130 to drive plate 80. In one embodiment, outer leaf spring 126 is used to secure piston plate 130 directly to cover 110. In one embodiment, inner leaf spring 125 is used to secure piston plate 130 directly to radial annular cover component 114.

Piston plate 130 includes inner piston rivet 116 and outer piston rivet 117. Inner leaf spring 125 attaches to cover rivet 115 and inner piston rivet 116 in order to secure piston plate 130 to radial annular cover component 114. Outer leaf spring 126 attaches to inner radial cover surface 112 and outer piston rivet 117 in order to secure piston plate 130 to inner radial cover surface 112. In one embodiment, inner leaf spring 125 is configured to allow axial movement of piston plate 130 but prevent rotational movement of piston plate 130 relative to cover 110. In one embodiment, outer leaf spring 126 is configured to allow axial movement of piston plate 130 but prevent rotational movement of piston plate 130 relative to cover 110.

Referring to FIGS. 2 and 3, piston plate 130 is defined by axial piston crown 132, radial annular piston surface 134, and axial piston skirt 138 to form a generally flat annulus, and includes notch 140, inner piston rivet 116, and outer piston rivet 117. Piston plate 130 is configured to be aligned, via notch 140, along rotational axis A and relative to torque converter 100 for a riveting assembly process in torque converter 100. Piston plate 130, in conjunction with a drive plate 80 and cover 110, is configured to function as a lock-up clutch to engage or disengage input and output shafts of torque converter 100. Piston plate 130 is hydraulically controlled to engage or disengage friction contact surfaces (not shown) on inner radial cover surface 112, as shown in FIGS. 2 and 3. When piston plate 130 is pressurized equally on both sides, piston plate 130 cannot engage inner radial cover surface 112. When piston plate 130 is pressurized unequally on both sides, the difference in pressure across the two sides of piston plate 130 causes piston plate 130 to slide toward cover 110 of torque converter 100 and piston plate 130 can engage inner radial cover surface 112.

Notch 140 on outer annular piston edge 139 of piston plate 130 is configured to align piston plate 130 relative to torque converter 100. Notch 140 is configured to align piston plate 130 for a riveting assembly process of torque converter 100. Notch 140 is stamped into outer annular piston edge 139 of piston plate 130. In one embodiment, notch 140 is configured to align piston plate 130 for a blind riveting assembly process of torque converter 100. In one embodiment, notch 140 is configured to align piston plate 130 for a blind riveting assembly process of drive plate 80. In one embodiment, notch 140 is configured to align piston plate 130 for a blind riveting assembly process of cover 110. In one embodiment, notch 140 is configured to align piston plate 130 relative to drive plate 80. In one embodiment, notch 140 is configured to align piston plate 130 relative to cover 110. In one embodiment, notch 140 is crescent or half-moon shaped. In one embodiment, notch 140 is an arc shaped bevel. In one embodiment, notch 140 is a plurality of notches 140. For example, the plurality of notches 140 can each be equally spaced from one another on outer annular piston edge 139. In one embodiment, notch 140 extends radially inward from outer annular piston edge 139 to less than a cross sectional centerline of axial piston skirt 138. In one embodiment, notch 140 extends along the entire axial length of axial piston skirt 138. In one embodiment, notch 140 extends along less than an axial centerline length of axial piston skirt 138. In some embodiments, notch 140 is a concave shaped recess. In some embodiments, a concave shaped recess can be formed as notch 140 by machining or molding piston plate 130. In some embodiments, a concave shaped recess can be formed as notch 140 by machining or molding axial piston skirt 138. In some embodiments, notch 140 can be a bevel, a chamfer, an arc shape, or any other suitable shape to align piston plate 130 without compromising a functional surface of piston plate 130 or a seal (not shown).

It is to be appreciated that the Detailed Description section, and not the Brief Summary and Abstract sections, is intended to be used to interpret the claims. The Summary and Abstract sections may set forth one or more but not all exemplary embodiments of the stamped notch piston plate for a torque converter as contemplated by the inventor, and thus, are not intended to limit the present embodiments and the appended claims in any way.

The foregoing description of the specific embodiments will so fully reveal the general nature of embodiments that others can, by applying knowledge within the skill of the art, readily modify and/or adapt for various applications of such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

### PARTS LIST

80 drive plate
90 impeller shell
100 torque converter
110 cover
111 radial cover wall
112 inner radial cover surface
114 radial annular cover component
115 cover rivet
116 inner piston rivet
117 outer piston rivet
119 radial annular cover rivet
125 inner leaf spring
126 outer leaf spring
130 piston plate
132 axial piston crown
133 inner annular piston edge
134 radial annular piston surface
138 axial piston skirt
139 outer annular piston edge
140 notch
A rotational axis

What is claimed is:

1. A piston assembly for a torque converter, the piston assembly comprising:
a piston plate comprising:
an axial inner crown comprising an inner annular edge;
a radial annular surface coupled to the axial inner crown;
an axial skirt comprising an outer annular edge and coupled to the radial annular surface; and
a notch disposed in the outer annular edge of the axial skirt and configured to align the piston assembly relative to the torque converter.

2. The piston assembly of claim 1, wherein the notch is crescent or half-moon shaped.

3. The piston assembly of claim 1, wherein the notch comprises an arc shaped bevel.

4. The piston assembly of claim 1, wherein the notch comprises a plurality of notches, and each notch is equally spaced from one another on the outer annular edge.

5. The piston assembly of claim 1, wherein the notch extends radially inward from the outer annular edge to less than a cross sectional centerline of the axial skirt.

6. The piston assembly of claim 1, wherein the notch is configured to align the piston assembly for a blind riveting assembly process of the torque converter.

7. The piston assembly of claim 1, wherein the notch is stamped into the outer annular edge.

8. The piston assembly of claim 1, further comprising an inner rivet disposed in the radial annular surface.

9. The piston assembly of claim 8, further comprising an inner leaf spring configured to attach to the inner rivet.

10. The piston assembly of claim 1, further comprising an outer rivet disposed in the radial annular surface.

11. The piston assembly of claim 10, further comprising an outer leaf spring configured to attach to the outer rivet.

12. A torque converter, comprising:
a cover comprising an inner radial surface;
a drive plate comprising an annular plate and at least one aperture, the drive plate configured to be rotationally fixed to the cover; and
a piston assembly coupled to the drive plate, comprising:
a piston plate comprising:
an axial inner crown including an inner annular edge;
a radial annular surface coupled to the axial inner crown;
an axial skirt including an outer annular edge and coupled to the radial annular surface;
a notch disposed in the outer annular edge of the axial skirt and configured to align the piston assembly relative to the torque converter; and
a piston rivet disposed in the radial annular surface; and
a leaf spring, having a first end and a second end, attached to the piston rivet,
wherein the first end of the leaf spring is attached to the drive plate or the cover and the second end is attached to the piston rivet such that the piston assembly is axially moveable and rotationally immovable relative to the cover.

13. The torque converter of claim 12, wherein the notch is crescent or half-moon shaped.

14. The torque converter of claim 12, wherein the notch is an arc shaped bevel.

15. The torque converter of claim 12, wherein the notch is a plurality of notches, and each notch is equally spaced from one another on the outer annular edge.

16. The torque converter of claim 12, wherein the notch extends radially inward from the outer annular edge to less than a cross sectional centerline of the axial skirt.

17. The torque converter of claim 12, wherein the notch is configured to align the piston assembly for a blind riveting assembly process of the torque converter.

18. The torque converter of claim 12, wherein the notch is stamped into the outer annular edge.

19. A piston plate for a torque converter, the piston plate comprising:
an axial inner crown including an inner annular edge;
a radial annular surface coupled to the axial inner crown;
an axial skirt including an outer annular edge and coupled to the radial annular surface; and
a notch disposed in the outer annular edge of the axial skirt and configured to align the piston plate relative to the torque converter.

20. The piston plate of claim 19, wherein the notch is crescent or half-moon shaped, and the notch is a plurality of notches.
